(19) United States
(12) Patent Application Publication
(10) Pub. No.: US 2017/0135057 A1
(43) Pub. Date: May 11, 2017

(54) CHEERING SYSTEM

(71) Applicant: Smarter Apps, Inc., Vista, CA (US)

(72) Inventors: Mario A. Cugini, Vista, CA (US); Charles W. Currey, Vista, CA (US); Conrad Frame, Carlsbad, CA (US)

(73) Assignee: Smarter Apps, Inc., Vista, CA (US)

(21) Appl. No.: 14/934,079

(22) Filed: Nov. 5, 2015

(51) Int. Cl. H04W 56/00; H04W 76/02; H05B 37/02; H04W 4/02

(52) U.S. Cl. CPC H04W 56/0025; H04W 4/02; H04W 76/02; H05B 37/0281; H05B 37/0272

(57) ABSTRACT

A cheering system has a plurality of mobile devices, each device having one or more lights configured to display multiple colors and patterns, a battery connected to the light, a microcontroller configured to determine the colors and patterns shown by the one or more lights, wherein the microcontroller contains a control program to control the output of the light, a network controller having a wireless network connection, wherein the one or more lights, the battery and the network controller are in communication with the microcontroller and a server having a time, wherein the device is connected to the server through a wireless network, and wherein each device establishes its own time delta against the central server time so as to synchronize the devices.

### BACKGROUND OF THE INVENTION

1.Field of Invention

This invention relates to systems for cheering for a sports team or other exhibition, and particularly to a networked system to provide uniform cheering capabilities.

2.Description of Related Art

In the past, fans supported events such as concerts or other entertainment events, and cheered for their team by clapping, singing songs or chanting, doing “the wave” and other analog coordinated activities, typically coordinated by one fan seeing the effect of other fans and joining in. Handheld lights (such as lighters) the use of which was coordinated by users have been used during darkened events to show support and were heightened by the simultaneous, coordinated display of many attendees. Even multiple camera flashes have been used to provide effects in a darkened stadium.

With the advent of smartphones and mobile electronic devices emitting light, the screen may be used to show light or a particular color, set individually by a user. However, there is a need for a system that communicates between the devices to provide a coordinated effect in a darkened stadium to show support for a team. Also beneficial would be the system knowing each device's location to provide a further coordinated light show or image for display.

### SUMMARY OF THE INVENTION

A cheering system has a plurality of mobile devices, each device having one or more lights configured to display multiple colors and patterns, a battery connected to the light, a microcontroller configured to determine the colors and patterns shown by the one or more lights, wherein the microcontroller contains a control program to control the output of the light, a network controller having a wireless network connection, wherein the one or more lights, the battery and the network controller are in communication with the microcontroller and a server having a time, wherein the device is connected to the server through a wireless network, and wherein each device establishes its own time delta against the central server time so as to synchronize the devices.

In one embodiment each device has a GPS unit in communication with the microcontroller, to communicate the position of the device to the server such that the one or more lights of each device are coordinated with other devices. Each device may also have a speaker configured to play music.

A method for a cheering system has the steps of initializing a system on a portable device, connecting to a network, synchronizing the portable device with a server, determining a delta from a server time for the portable device, adjusting the timing of a display of the portable device to the delta such that the device is synchronized with other portable devices nearby also connected with the server, and displaying a synchronized pattern on the portable device. The method may have the additional step of the user selecting the pattern.

The synchronization may have the steps of the device pinging the server to receive the delta or offset from the server time, adding the delta to the device clock to synchronize the program with the server time, such that all devices are able to display the program or pattern with identical timing, and repeating the pinging of the device a plurality of times to receive a consistent average. The synchronization may be repeated until the results are relatively consistent.

Further steps of preparing one or more data structures for pattern colors, timing and brightness, may be included, as well as determining what color the pattern is on using the offset, displaying the color, determining the delay to the next color, starting a base timer for determining the pattern changes. The base timer may be 0.25 seconds, and the program may loop through the data structures by reference to the base timer.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a functional diagrams of presently preferred embodiments of a stadium cheering system, according to an embodiment of the present invention; and

FIG. 2 is a logic chart of presently preferred embodiments of a stadium cheering system, according to an embodiment of the present invention.

### DETAILED DESCRIPTION OF PREFERRED EMBODIMENTS

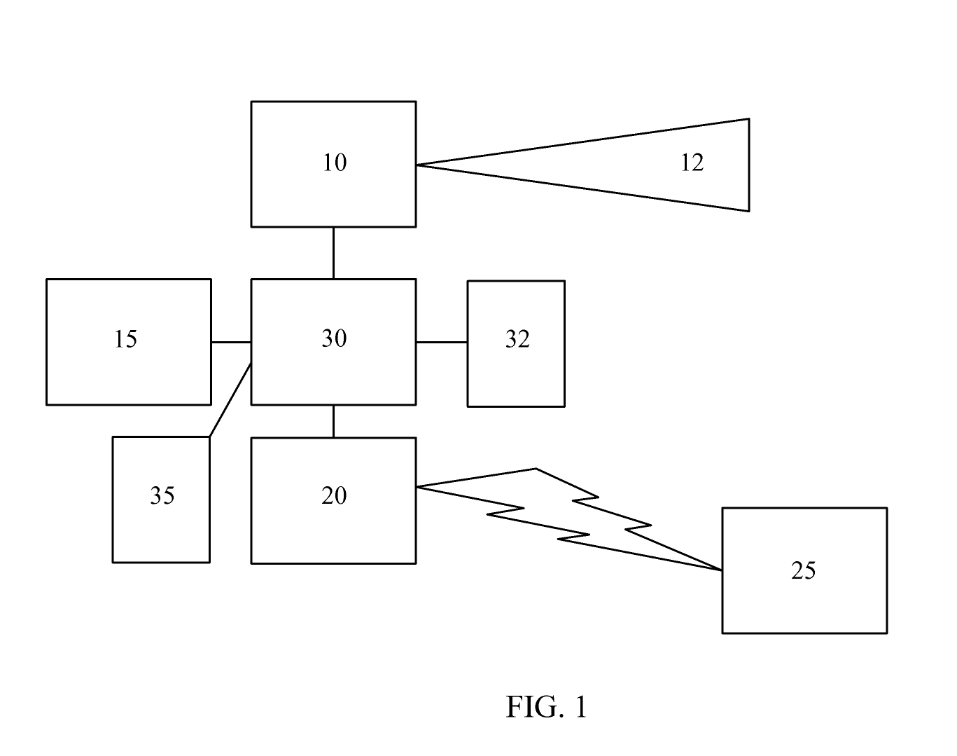

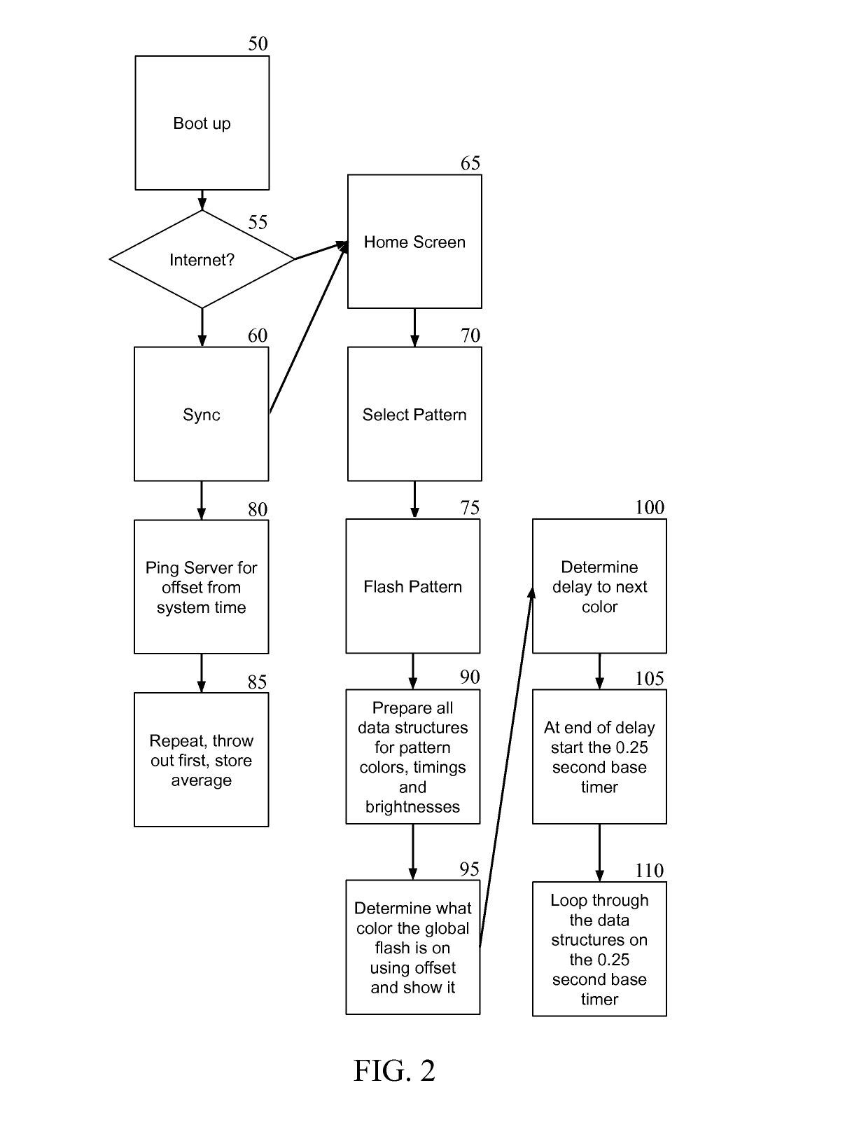

Preferred embodiments of the present invention and their advantages may be understood by referring to FIGS. 1-2 wherein like reference numerals refer to like elements.

FIG. 1 is a functional diagram of a stadium cheering system. The cheering system uses hardware including a light 10 capable of showing multiple colors, that is powered by a battery 15 and is networked with a server 25 through a wireless network. Each device establishes its own time delta against the central server. The light 10 has a microcontroller 30 to determine the light patterns that are being shown, and the microcontroller 30 may contain a control program to control the output of the light, with reference to other lights that are networked. The system also has a network controller 20 to enable remote communication with the server and/or other devices. The light 10, battery 15 and network controller 20 are in communication with the microcontroller 30

The light may also have a GPS capability 32 to communicate the position to the other lights so a larger image may be coordinated based on the position of the lights across the stadium. In this embodiment, the phones would communicate position to a central unit which would then coordinate. A GPS unit 32 would be in communication with the microcontroller 30.

The light may have a speaker 35 to play music or sound on its own or synchronized with other units in the stadium. For example, a smartphone would generally have an external speaker to play sounds. The speaker 35 would be in communication with the microcontroller 30.

In one embodiment, the hardware is a mobile device such as a smartphone. An control program may be installed, which controls the output of the screen of the smartphone.

With reference to FIG. 2, in step 50 the system initializes and boots up. In step 55 the system connects to a network, and in step 60 the synchronization with the server is achieved, such that the program on the system determines a delta from the server time, and adjusts the timing of the display to the delta, and is therefore synched with other devices nearby that also synch in an identical way. Once the system has a network connection and is synchronized with the server, in step 65 a home screen is shown. In step 70 the user selects a pattern or other features of the system, and in step 75 the pattern is displayed, and sounds produced, etc. as the system proceeds through the program.

In step 60, the device is synched to the server. Synchronization is made up of step 80, wherein the device pings the server to receive the delta or offset from the server time, such that the delta is added to the device clock to synchronize the program with the server time, such that all devices are able to display the program or pattern with identical timing. In step 85, the ping of step 80 is repeated a plurality of times, with the first and lest results discarded in an embodiment to receive a meaningful average. In an embodiment, if the results vary widely, the process is completed until the results are relatively consistent.

In step 75, the pattern flash is executed. This is achieved by the following steps. Step 90 prepares all data structures for pattern colors, timing and brightness. The program may also have some sound control. In step 95, the device determines what color the global flash is on using offset and show it. In step 100, the delay to the next color is determined. In step 105, at the end of the delay, the base timer for determining the pattern changes is started. In an embodiment, the base timer is 0.25 seconds. In step 110, the program loops through the data structures by reference to the base timer.

By using the control program, the user can select and display a pattern of images, for example colors, letters, or words on the light, smart phone or tablet. Many such patterns can be made available for users to choose from, and may be centrally stored and selected and downloaded through the system or a website. A library of patterns may also be stored in the memory of the light or smartphone, to be accessed by the user, or selected by a central control system. The patterns are related to current time, and each device downloads the pattern and the timing of colors, breaks etc. of the pattern. Then, the device refers to its internal clock while performing the patterns, obviating the need for a constant connection with a server to synchronize and the consequent data usage of such a connection. All mobile devices will be able to synchronize due to the shared objective time measurement. One source of an objective clock is a server that operates on Google's cloud processing service that just runs a time clock.

In an embodiment, users select which pattern to display manually, and each device synchronizes with the central server independently. Devices do not communicate with each other.

The images displayed may represent the colors of a team, the colors or patterns of a flag, display of other specific data relevant to an event that may be located in a stadium, for example a sports event, a wedding, a concert, a political event, a corporate event. The system may be used for individual or group cheering, support, or simply displaying pride, similar to the purpose of a pin on a lapel. The system may also be used to complement the entertainment or be a part of the entertainment. As another example, schools or any organization desiring representation in a social setting may use the system for supporting their sports team or other aspects of the school. Schools create custom patterns for use at events like graduations - which may or may not be in a stadium. People may also use this system to join a cheer or “Flash” from a remote location to the event, like a sports bar, and be confident their phone or tablet is flashing in synchronized rhythm with those at the actual game. Again, in this embodiment the device downloads the pattern, which subsequently operates from the objective time measure synchronized to the device.

A pattern could have as many images as deemed necessary, and pattern images may be used in a still image or as a part of video, and could be used to tell a story, much like a cartoon, or simulate motion, like a flag in different positions. Pattern could also include sound through a device's speaker, wherein in an embodiment pattern timing could be matched to the sound (such as a song's rhythm).

The pattern of images (length of time each image is displayed) is timed according to how their “on air” time is pre-programmed. The pattern will repeat itself continuously.

As an example, a pattern with three images could appear on the phone's screen, as follows: image 1 for 2 seconds, image 2 for 1 second, and image 3 for 0.5 seconds. The pattern will then repeat itself continuously.

As a secondary and very significant feature, is that the displayed of these patterns is “synchronized” across all devices displaying it. As an example, if a team pattern is displayed during a game, everyone displaying that pattern will be synchronized, regardless of their specific location. They could be in the stadium, outside the stadium, in a sports bar, or in a different time zone. In an embodiment, the invention is distinguished from multiplayer games or streaming services that need a constant network connection to run and to stay in sync. The system uses a combination of background syncing (as a background process on the device) and foreground syncing to briefly establish a time delta against a central server compared to the phone's clock. The phone then uses this delta to sync the pattern without requiring a continuing connection, once the pattern is downloaded to the device. This means this can be accomplished with a relatively small discrete transmission rather than a constant, bandwidth heavy stream.

A simple time clock service for these purposes runs on a reliable central time clock service as operated by a redundant cloud computing provider, such as a server in Google's cloud. Each device checks against the central time server and compares its time to that of the time server. Example: If an iPhone shows 5:01:23:15 PM PST and the first image in the pattern is scheduled to begin at 5:01:24 and the time server reports 5:01:23:00 PM PST, the app then understands the phone is 00:00:23 ahead and must delay by this amount.

Synchronization is accomplished by each device having made recent communication with a central server. The devices communicate with the central server often to obtain timing offsets or deltas. During a single communication event with the server numerous timing offset requests are sent and received, of which the first is discarded, and in an embodiment the remaining offsets are averaged, to obtain a current working offset, or average offset. In another embodiment, a standard deviation function is used and high and low bumpers are set for the numbers - anything too fast or too slow is removed from consideration.

The current working offset is then used in combination with the device's internal system clock to determine the timing of the global display and to display the pattern in synchronicity with other devices that are using the system.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A cheering system comprises:
a. at least one mobile device, each device comprising:
i. one or more lights configured to display multiple colors and patterns;
ii. a battery connected to the light;
iii. a microcontroller configured to determine the colors and patterns shown by the one or more lights, wherein the microcontroller contains a control program to control the output of the light;
iv. a network controller having a wireless network connection, wherein the one or more lights, the battery and the network controller are in communication with the microcontroller; and
b. a server having a time, wherein the device is connected to the server through a wireless network, and wherein each device establishes its own time delta against the central server time so as to synchronize the devices.

2. The system of claim 1 each device further comprising a GPS unit in communication with the microcontroller, to communicate the position of the device to the server such that the one or more lights of each device are coordinated with other devices.

3. The system of claim 1 further comprising a speaker configured to play music.

4. A method for a cheering system, comprising the steps of:
a. initializing a system on a portable device;
b. connecting to a network;
c. synchronizing the portable device with a server;
d. determining a delta from a server time for the portable device;
e. adjusting the timing of a display of the portable device to the delta such that the device is synchronized with other portable devices nearby also connected with the server; and
f. displaying a synchronized pattern on the portable device.

5. The method of claim 4, further comprising the steps of:
a. the user selecting the pattern.

6. The method of claim 4, wherein the synchronization further comprises the steps of:
a. the device pinging the server to receive the delta or offset from the server time;
b. adding the delta to the device clock to synchronize the program with the server time, such that all devices are able to display the program or pattern with identical timing; and
c. repeating the pinging of the device a plurality of times to receive a consistent average.

6. The method of claim 6, wherein if the results vary widely, the synchronization is repeated until the results are relatively consistent.

8. The method of step 4, wherein the step of displaying a synchronized pattern further comprises:
a. preparing one or more data structures for pattern colors, timing and brightness;
b. determining what color the pattern is on using the offset;
c. displaying the color;
d. determining the delay to the next color; and
e. starting a base timer for determining the pattern changes.

9. The method of step 8 wherein the base timer uses increments of less than 1 second.

10. The method of step 9 wherein the program loops through the data structures by reference to the base timer.
